(19) United States
(12) Patent Application Publication
(10) Pub. No.: US 2020/0097717 A1
(43) Pub. Date: Mar. 26, 2020

(54) AUTOMATED DOCUMENT PROCESSING

(71) Applicant: KODAK ALARIS INC., Rochester, NY (US)

(72) Inventors: Jonathan H. YOUNG, Rochester, NY (US); Peter PIELA, Rochester, NY (US)

(73) Assignee: KODAK ALARIS INC., Rochester, NY (US)

(21) Appl. No.: 16/580,208

(22) Filed: Sep. 24, 2019

Related U.S. Application Data
(60) Provisional application No. 62/735,449, filed on Sep. 24, 2018.

(51) Int. Cl. G06K 9/00; G06N 3/08; G06N 7/00

(52) U.S. Cl. CPC G06K 9/00469; G06N 7/005; G06N 3/08

(57) ABSTRACT

A system is described whereby a classifier can label pages of a document. Preliminary classification can be performed on a page-by-page basis based on the content and form of each individual page. The system can then perform a sequence-based classification based on the preliminary classification of preceding and following pages. This approach can use a hidden Markov model and can result in more accurate page labels in a document

### CROSS REFERENCE TO RELATED APPLICATION

The present application relates to and claims priority from U.S. provisional patent application entitled AUTOMATED DOCUMENT PROCESSING, Ser. No. 62/735,449, filed on Sep. 24, 2018. The disclosure of the above-identified provisional application is hereby incorporated by reference in its entirety.

### BACKGROUND OF THE INVENTION

Document ingestion and processing traditionally require significant human attention. Data entry specialists might receive a collection of papers and must separate the collection into individual documents, identify the pages of the documents, and isolate fields in those pages. This process is error-prone, slow, and requires significant training for the specialists. Exacerbating these problems is the fact that documents can be of variable length, they can be presented in any order, and pages might be misfiled.

### BRIEF DESCRIPTION OF THE DRAWINGS

Various embodiments in accordance with the present disclosure will be described with reference to the drawings, in which:

FIG. 1 presents how a system can process a package.

FIG. 2 shows a Hidden Markov Model being applied to page identification.

FIG. 3 illustrates an example loan ingest system.

FIG. 4 illustrates an example batch processing workflow.

### DETAILED DESCRIPTION OF THE INVENTION

Disclosed herein are techniques for automated document ingestion and processing. One challenge with automatic document processing is that multiple documents, each possibly having multiple pages, might be submitted as a lump package. For example, a loan originator might submit a package of documents that contain a W2, a 1040, signed documents, etc. This package might comprise scanned images of documents without metadata specifying document types or document fields. The documents might be in a random order and have unpredictable lengths. Further documents might be missing pages and pages in the package might be misplaced, missing, or out of order. Separating the package into individual documents can be difficult as stray pages might have accidentally been inserted within a document, certain document types might have a variable number of pages, some pages of a document might be omitted, etc. Furthermore, some scanned images are low quality or generally featureless and are thus difficult to identify.

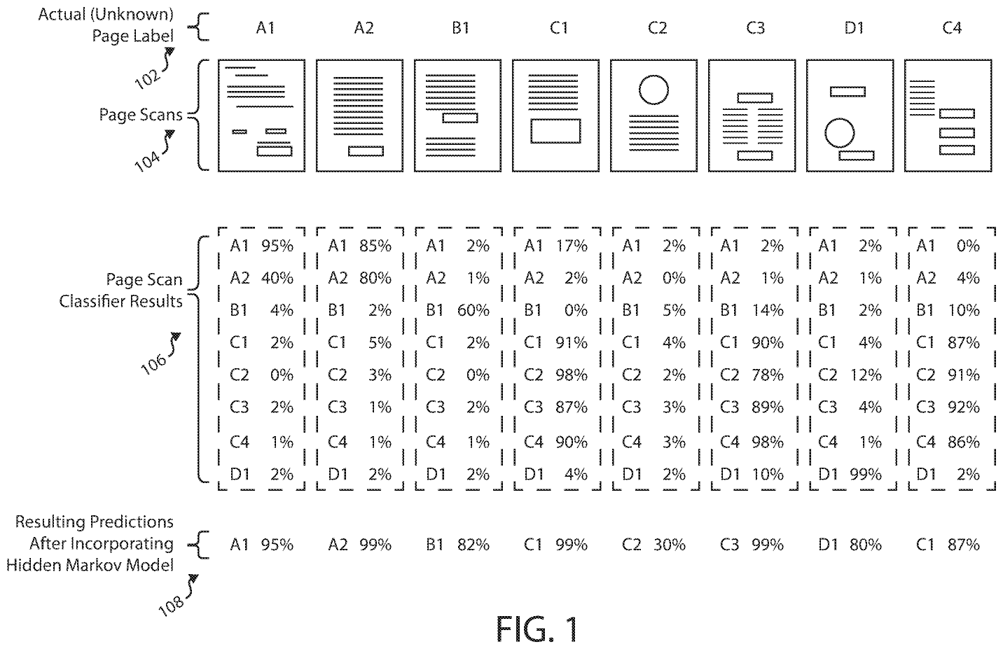

FIG. 1 presents how a system can process a package. A system can receive a package of documents comprising various pages. For example, in FIG. 1, there are pages A1, A2, B1, C1, C2, C3 D1, and C4 (104). These pages can be associated with document types “A”, “B”, “C”, and “D”. Each document type can be associated with multiple pages (e.g., document “C” can be associated with numbered pages C1, C2, and C3). Note how D1 erroneously is located before C4. Having D1 before C4 might cause some systems to erroneously assign C4 its own document and not associate it with C1, C2, or C3. The package might include image scans of the pages and lack any metadata identifying pages, document types, or document fields. At least one key benefit of the principles disclosed herein is to assign correct page labels to the page scans 104.

The system can submit the unlabeled pages to a classifier. The classifier can be trained to generate page scan classifier results 106 which can be representative of what page label probabilities that classifier determines the pages likely are. For example, the classifier determined that there's a 95% similarity between the first page scan and the A1 label. This can be interpreted as the system determining a 95% likelihood that the page is that label. While the page scan classifier results might at times sum to greater than or less than 100%, a processing step can normalize the classifier results (e.g., to enforce a 100% sum).

The classifier can ingest various data about a page. For example, the classifier can perform an optical character recognition step on the page. The classifier can utilize a convolutional neural network to analyze images on the page. The classifier can identify lines, patterns, text, logos, fields, colors, spaces, bar-codes, signature blocks, etc. in the page and such components can be used as part of classification. The classifier can review a size and color of a page. The classifier can be trained on a large and diverse test set of pages. The test set can include sample pages and the intended classification. Machine learning classification algorithms can be implemented to train the classifier.

The classifier might only be trained to identify the document type of the page. For example, the classifier can identify a page as a 1040 tax form but does not determine which part of the 1040 the page is (e.g., page 1 or page 2). Additionally or alternatively, the system can identify the “page type” for a page. The page type can specify a document type and a page number (e.g., page 2 of 1040). The page type can specify a section number or heading. The page type might not necessarily be exclusive to a document type; for example a “fax cover page” type can be applicable to multiple document types. The page type predictions roughly correspond to the vector result shown in FIG. 1. For example, the system can identify that a scanned page (e.g., the first page in FIG. 1) corresponds to a 95% score for page type A1, a 40% score for page type A2, and so on.

Using just a classifier can be error prone. For example, the A2 page is given an 85% similarity to A1 and an 80% similarity to A2; thus a pure classifier might label it as A1 incorrectly. Similarly, in a large document type of many pages, certain pages might be difficult to label by themselves. For example, C2 has classifier results that are rather indeterminate indicating that the classifier is unable to assign any labels to the page. This might happen if a page is generally blank or featureless. Therefore, only using a classifier might result in misidentification, duplicate labels, and pages being identified out of order (e.g., the system determines the correct document type, but the incorrect page).

The system can then, using a Hidden Markov Model and the classifier results, determine predictions 108 for each page. For example, the system can predict that the first page is page type A1 with a 95% confidence, that the second page is page type A2 with a 99% confidence, etc.

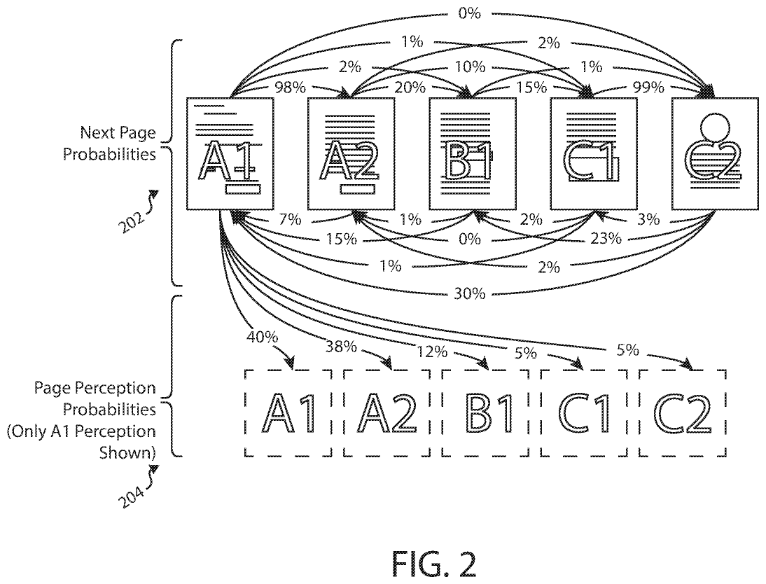

FIG. 2 shows a Hidden Markov Model being applied to page identification. For example, the top section 202 can represent the state change probabilities between different states. In other words, the top section 202 can indicate probabilities that certain page types follow other page types. For convenience, not all page types are shown and the displayed sum probabilities might not add to 100%. For example, if a page type A1 is first, then page type A2 will follow with a 98% likelihood, page type B1 will follow with a 2% likelihood, etc. This accounts for pages being omitted, out of order, duplicated, etc. If A2 is identified, then there is a 7% chance the next page type will be A1 (e.g., the pages are out of order), a 20% chance page type B1 follows, and a 10% chance that page type C1 follows. Some documents may bind the pages together (e.g., using a staple) while other document pages may be loose when handled, allowing people to remove and insert pages. This results in some documents having higher likelihood that pages are out of order.

It should be understood that the next page type probabilities 202 of the upper section of FIG. 2 represent the actual page types that have been observed. Thus, the system can be trained using labelled data comprising lists of page type arrangements. For example the training data can include “C1->C2->B1”, “A1->B1->A2->C1->C2”, etc. The system can use various techniques to establish the probability that page types that will follow a certain page type.

It should be understood that the “states” herein are frequently discussed as being “page types,” however sequences of page types can also be considered a state. For example, “A1->A2” can be a state and “A1->B1” can be a state. Continuing the example, the transition from “A1->B2” to “B2->A2” can be associated with a moderate percentage chance, capturing the possibility that B2 was erroneously inserted within the sequence. This has the benefit that a new page type decision can be informed by historical pages and not just the preceding page. A state change can be represented by a historical state. For example, while not shown in FIG. 2, a probability can be shown that A2 will follow A1 when A1 was observed two pages ago. Thus, if B1 follows A1, then the probability that A2 is next can be proportional to P(A2|B1ₜ₋₁)*P(A2|A1ₜ₋₂). In other words, the system can determine the probability of a certain current page type based on the page or pages that preceded it and/or the page or pages that follow it. The current page probability can be based on previous pages, regardless of the proximity to the current page (e.g., if page A1 precedes the current page—whether it is the page before or 10 pages before—the system can determine that the current page is not likely A1, B1, or C3).

Each state (e.g., page type) can be associated with a perception probability or probabilities. For example, page type A1 can be associated with a 40% chance of being correctly identified as A1, a 38% of being labelled A2, a 12% of being labelled B1, a 5% chance of being labelled C1 and a 5% chance of being labelled C2. These perception percentages can correspond to the vector that the classifier generates, as discussed with FIG. 1. For example, the classifier can classify a batch of A1 pages and the resulting vectors can be averaged to establish the perception probabilities (ignoring preceding and following states). Where the state corresponds to two or more pages, the page perception probabilities can be associated with the ultimate page.

An example application of these techniques is as follows. Using the first three pages of the model described in FIG. 2 and the first page has a 100% chance of being A1 (this obviously is not a requirement but a simplification for explanation), one can calculate possible three page sequences given the algorithm perceived pages A1, A2, and B1. For example, the state A1->A2->B1 can be calculated with a value of P(A1)*P(A2|A1)*P(B1|A2)*P(a1|A1)*P(a2|A2)*P(b1|B1) where a1 is the perceived A1. Note that this is not P(A1,A2,B1|a1,a2,b1) because it is not normalized, but it can be used for comparison against other chains. The state chain with the highest value can be considered the actual pages.

To calculate the most probable page types, the system can create “chains” of possible page types. For example, one chain might include predictions A1 for page 1, A3 for page 2, B2 for page 3, etc. The system can create chains of all possibilities. An algorithm can be employed to compare full chains or portions of chains to determine a most probable chain. This most probable chain can thus indicate the most likely page types for each page type in the package.

The perceived state can be the result of the classifier, such as a vector that the classifier outputs can be the perceived state of the page.

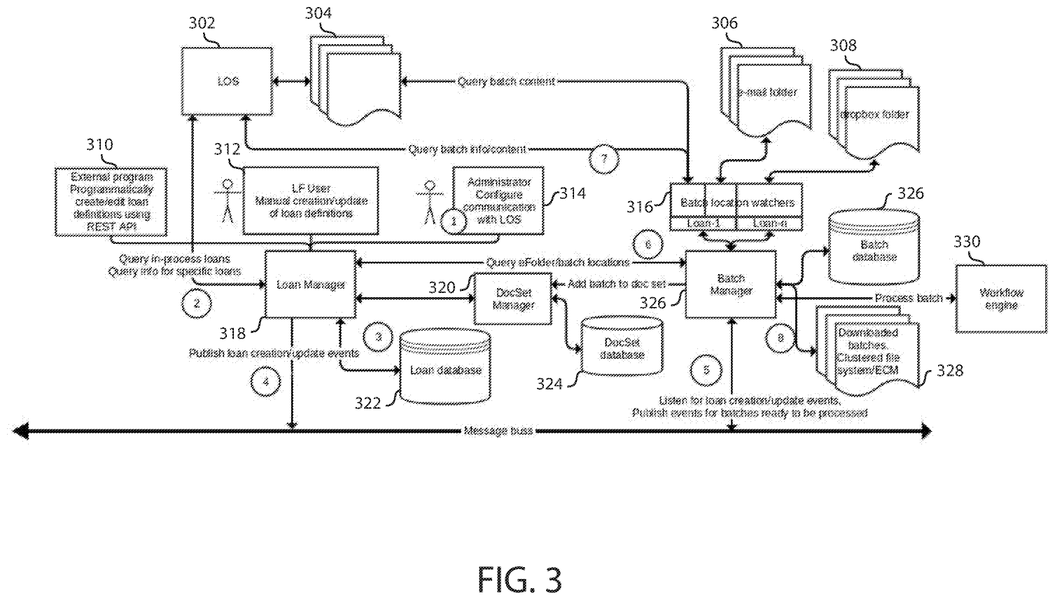

FIG. 3 illustrates an example loan ingest system. The loan origination system (LOS) can interact with a loan connector 302 to determine new loans to be process and create document-packages to represent the loans. Email folders 306 and cloud-based folders 308 can provide files for batch location watchers 316 to review for new documents. The batch manager 326 can connect to the batch location watchers 316, the batch database 326, the downloaded batches, clustered file system/ECM 328, and docset manager 320 to process batches and communicate with the workflow engine 330. Batch manager 326 can also listen for loan creation/update events and publish events for batches ready to be processed. The docset manager 320 can communicate with the docset database 324, and the loan manager 318. The loan manager 318 can communicate with the loan database 322 and the LOS 302. The loan manager 318 can communicate with the LF user manual creation/update of loan definitions 312 and the administration configure communication with the LOS 314. External programs 310 can programmatically create/edit loan definitions using a REST API.

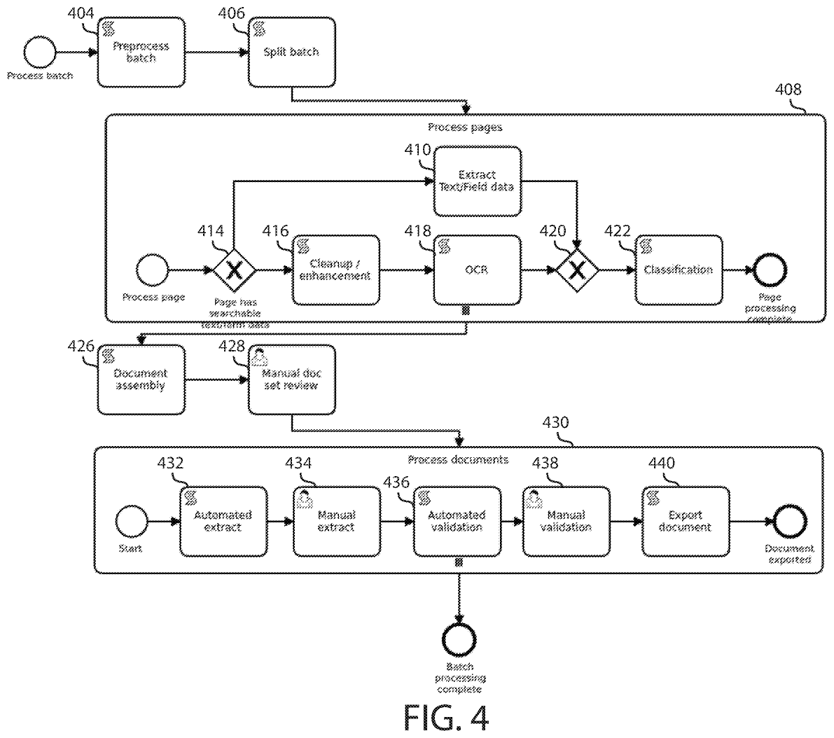

FIG. 4 illustrates an example batch processing workflow. A batch can be received and can pass through a preprocessing step 404. Preprocessing can include applying filters, correcting for rotation/skew, modifying the brightness of the image, de-noising the image, correcting for deformations, correcting the contrast, etc. The batch can be split 406. For example, the batch can be split into individual pages or groups of pages. Some images can be split into multiple pages or image segments.

The pages can then pass through a process pages subroutine 408. The system can determine if the page is already searchable 414 and if it is it can pass through path 410 to 420.

The system can extract text and field data from the pages 410. For example, the system can read metadata, XML data, and other structured data that may be included in the page. If the page is not searchable, the system can do image cleanup and enhancement 416 and then perform optical character recognition (OCR) on the page 418 to extract text. With the text extracted, the system can proceed to classify 422 the page. For example, the system can determine a vector of probable types for the page.

The system can then send the document (e.g., a set of pages from the batch) through a document assembly subroutine 426. The document assembly 426 subroutine can use the techniques describes with FIGS. 1 and 2 to intelligently bundle pages together. The document can then be sent to a person from manual review 428.

The document can then be sent through a validation and export subroutine 430. The system can automatically extract 432, and/or manually extract 434 fields from the document. This can include labelling text in the document as applying to certain fields (e.g., phone number, name, or address). The system can then pass the document through automated validation 436 process. Validation can include ensuring the fields fulfill the requirements for the document type. For example, if a signature is required for a document, the validation system can determine that the signature is provided. Manual validation 438 can also be performed. The document can then be exported 440 and sent to a customer, third party, bank, etc.

A document processing system can be developed as a tiered application. Tiers can include: (1) generic core foundation services (which can include a portal-like UI framework, authentication/authorization systems, workflow definition and execution systems, a rules engine, an integrated message bus, and resource management systems), (2) document processing services, and (3) domain specific modules. The document processing system can be cloud compatible, deployable, and take advantage of capabilities such as multi-tenancy and elasticity.

### Foundation Tier

Overall Architecture

To satisfy a desire for the platform to deliver end-user portals, a ready-made portal development framework can be used. A microservices architecture can be used to enable a continuous integration and delivery model. This enables delivery of new features and patches in an incremental manner at a relatively high frequency. To the extent possible, microservices can be stateless. The architecture can support high availability (no single point of hardware/software failure). An active-active approach to high availability is preferred over active-passive. The architecture can support a scale-out deployment strategy with multiple instances of individual services. Individual services need not make assumptions about the location of other components. REST APIs can be versioned. The database-per-service pattern can be used. All private/personal document data can be encrypted-at-rest. In order to satisfy customer Service Level Agreements (SLAs), a combination of external monitoring tools and in-built SLA reporting can be used. Individual services can feed processing statistics to an SLA monitoring service.

Build/Packaging/Deployment

The document processing system can be deployed into both public clouds and/or on-premise infrastructure. The document processing system can be deployed on Windows, Linux, and hybrid clusters. The document processing system can support zero downtime upgrades across two major versions (e.g., from 1.x to 2.x). Individual components can be updated asynchronously (e.g., Linux OS updates). A combination of Docker and Kubernetes can be used to deploy the document processing system. Reference architectures can exist for all common deployment scenarios including: single-server, HA, multi-node compute cluster. The architectures can cover management servers, compute servers, load balancers, and security appliances. Support for deploying a complete cluster from a single installer can be supported.

User Interface Framework

The document processing system can support multiple portals in a single instance (e.g., Internet accessible consumer facing and behind the firewall back-office processing). Portals can support role-based and personalized layouts composed of separate application modules. The UI framework can provide a container for individual application UIs, the capability to organize application UIs into views, and the ability to navigate between those views. UIs can be accessible from standard browsers and mobile devices. UIs can be skinnable to match customer's branding/theming requirements

Authentication/Authorization/User Management

This service can have a configuration UI/CLI and REST API. An administrator can configure the set of supported authentication methods. A minimum of local user database and integration with LDAP/AD can be supported in the document processing system. Support for SSO/SAML/OAuth can also be supported. The authentication service can support pluggable drivers for different backend providers (e.g., KeyCloak, OpenStack Keystone, and Kong api-gateway). An administrator can manage the document processing system application users (e.g group, role, and contact information). Typical roles can be administrator, business-analyst, operator, reviewer, and manager. A user can self-authenticate to use the document processing system application. In addition to verifying identity, the authentication process can return information (e.g. a token) that can be used to determine the set of functions that a user is able to access (authorization).

Workflow Definition and Execution

The service can have a UI that supports (1) building and editing of process definitions and (2) visualization and monitoring of running processes. The document processing system can enable users to create, execute, and monitor multi-activity processes. The workflow engine can efficiently support workflows that comprise large numbers of automated short duration tasks with many parallel concurrent threads punctuated with longer duration human tasks. Workflow tasks can be idempotent. The workflow framework can be based on open standards such as BPMN. The workflow framework can utilize mature industry “standard” software. The workflow framework can provide tools for debugging process definition and execution, e.g., input validation and single step execution. The process execution engine can be performant and resource consumption can scale linearly with the number of executing process instances. Process topologies can contain activities executed in sequence and/or in parallel. Processes can be cyclic and repeat until a condition is satisfied. Activities can be fully automated tasks (implemented programmatically) that conform to a well-defined interface and/or manual operations involving one or more human beings. Processes can invoke independently defined sub-processes (e.g. a batch process can invoke page and document level processes). Processes can support a shared data context that is shared across all activities in the process. Individual activities can invoke particular microservices that can store data in their own databases.

Business rules can be associated with any activity or transition in a process. Each activity can produce a completion status. The process definition can define actions to be taken depending on step completion status and escalation for stalled manual steps. Processes are able to generate progress notifications. Published processes can typically contain a description of the topology in a notation such as BPMN. The compiled definition is deployed to the process execution engine from which instances can be created with different input parameters. The authoring tools in workflow frameworks can store process definitions in a configuration management system such as GIT and process definitions can be versioned. The process execution engine can publish events for the beginning and ending of each activity or task in a process.

The process execution engine must have the capability run activities on a cluster of processing nodes. The process execution engine can support audit and history logging that can be used for business activity monitoring.

Inter Component Communication

Asynchronous communication can be supported by a message bus like RabbitMQ. Point-to-point communication can utilize RESTful interfaces. All http-based communication can use SSL/TLS for secure transmission.

Business Rules Engine

Business rules processing is an important functionality for the document processing platform. Rules can be used to monitor and validate the completeness and accuracy of business processes running on the platform. Rulesets can be attached to individual entities and executed on demand or triggered by events. This service can have UI components for building, editing, executing, and visualizing the state of ruleset instances. The rules engine must be tightly integrated with the workflow engine and the entity types being processed. It can be possible to combine individual rulesets to make higher level inferences.

Analytics, Dashboarding, and Reporting Frameworks

The analytics framework can integrate with all platform services. The analytics framework can be used to track compute/cloud/cluster resource utilization. Predefined dashboards can be provided that track portal and workflow activity. A document processing system user can build custom dashboards for tracking specific items of interest. Dashboards can support the following configuration options: drag/drop layout of widgets and resizing of widgets. The same widget can be used in multiple dashboards and the user can create custom widgets. Dashboard configurations can be stored and used as templates for defining new dashboards. The following reports can be provided, and can be combined into custom dashboards: system health, cluster status, basic system metrics (e.g., load, CPU, memory, and disk utilization); and batches per status. Status values can include ERROR, FINISHED, READY_FOR_REVIEW, READY_FOR_VALIDATION, and RUNNING. Selecting a slice can display another pie chart showing a priority breakdown. Batches per priority can be shown as a pie chart or bar graph. Status information can also be displayed. A review and validate backlog report can include the number of batches waiting for operator input. Sorting can be based on how long the batch has been in the wait state. Pages processed per unit time can be presented as a line chart. A count of pages processed per selected loan type can be presented as a line graph for selected loans. The average pages processed can be presented as a gauge showing average number of pages per batch and per document. A throughput report by weekdays can be presented as a tabular view with the following columns: batch instance id, batch start date, batch end date, number of documents in batch, number of pages in batch, duration of execution, and operator duration. Similarly, throughput report for weekly processing and throughput report by batch size can be presented as a line chart and others.

Global Configuration Management

This serves a centralized configuration management for all the frameworks. This service can have a UI. An administrator can define process definitions and can assign it to respective execution of batch. An administrator can view and understand the current cluster. An administrator can change configurations of the cluster like number of cores to utilize and number of nodes. An administrator can verify the health of the cluster.

Resource Management/Scheduled Execution

To the extent possible, document processing system can support parallelization of workflows and execution across an elastic cluster of processing nodes. This functionality can be provided by the workflow engine itself. If not, it can require the use of an external resource manager that sits between the workflow engine and the backend microservices.

Centralized Logging

Given the distributed nature of Document processing system, a centralized logging solution can capture information from all microservices in a single repository that supports ad-hoc query and visualization. Examples of such logging solutions include the ELK (Elasticsearch-Logstash-Kibana) stack with correlation IDs to trace individual requests across multiple services.

Scripting Access to the Document Processing Pipeline

A capability can be provided for project personnel to be able to modify the behavior of the document processing pipeline without having to change the BPMN process definition. These parameters can be defined: points in the workflow that modifications can be injected, data that needs to be accessed, changes that can be made, and granularity rate which scripts can be provided (e.g. all loans, loan, batch, document, and page).

### Document Processing Tier

The document processing tier contains a set of “generic” services that operate on document-sets and their constituent components.

Document-Set

A document set is intended to represent a collection of documents delivered in batches and processed by the services in the document-processing tier. A Document-Set entity can include: a GUID; a list of properties (key/value pairs); a list of batch instance GUIDs; and an audit history. A batch entity can include a GUID, a ready-to-be-processed list, a list of properties (key/value pairs), a batch file name, and a batch directory. A folder with data (e.g. pages, thumbnails, HOCR) can be stored. The system can include content checksum (used to avoid redundant processing of batches), a list of page instance GUIDs, a list of processed-document instance GUIDs, a list of process-instance GUIDs (from the workflow engine) that have operated on this batch, a timestamp of when the document created, and a timestamp of when it was last processed (null if batch has not been processed).

A page entity can include: GUID; image filename (pre-cleaning); clean image filename; OCR filename; thumbnail filename; page type (a string) and page type confidence (a number between 0 and 100); auto page type (page-type determined via automated classification); classifications (an ordered list of possible (page) types and confidences); a list of properties (key/value pairs); a list of features (from OCR); a timestamp of when the item was created; and a timestamp of when the item was modified. A processed-document entity can include: a GUI; a document type (a string) and document type confidence (a number between 0 and 100); an auto document type (as determined by the document reassembler); classifications (an ordered list of (document) types and confidence); a list of page instance GUIDs; a list of internal properties (key/value pairs); and a list of extracted values (key/value pairs).

The batch splitter splits a batch into individual pages. Techniques can remove noise from and enhance page images for downstream processing. The system can use standard tooling such as ImageMagick and can provide intelligent default values for processing parameters. The system can allow advanced users (e.g., service personnel) to configure processing parameters on per batch and per project levels. Some of these functions are provided by OCR engines such as De-skew, Despeckle, Binarization, Line removal, and Normalize aspect ratio and scale.

Document-Type

Document-types are used to categorize documents using a set of shared features. A document-type can consist of an ordered list of page-types. The list of page-types is dependent on the structure of content within the document. The typical set of page types would be first-page, middle-page, last-page; however additional page-types can be added or removed to improve the quality of classification and extraction operations. The Document-type entity can include a GUID, a name, description of the item, and a list of page-types. A list of extractable fields can include a name, a type, a list of extraction rules, a bounding box (with location and dimensions), extraction directives, a list of format rules; and list of validation rules.

Document-Type Manager

The document-type manager is used to build and maintain a library of document types. These types are used as part of the both the document classification and extraction activities. The system can include a library of well-known document types for certain use cases (e.g., Mortgage processing). A document-type can define a set of fields (features) that are intended to be common to all documents of that type. This application can support CRUD operations for document-types. Field extraction rules are incrementally updated by adding new sample documents to the type and highlighting their field locations. The image-profiler may provide useful assistance. In order to improve automatic classification, analysts may associate blank images with document types and may specify the expected number of pages in a document type. This application has a UI for building and viewing document-types. Validation and formatting rules are applied to a field from a top level. If the document-type manager does not allow the definition of workflows, it can allow picking a workflow process definition from the workflow pool defined globally. This helps to avoid duplicate definition at the document type level. This helps to choose different workflows at different time easily. This helps to export and import workflows across the cluster and across the deployment pipeline. This allows administrators to export document-types and move them to different machines. All of the required configurations and data can be exported to compressed or proprietary format. This allows administrators to export and import fields, moving them to different document-type in the same or other location. Configurations and related data can be exported to compressed or proprietary format.

Page Classifier

The page classifier can classify pages into page types. A page type is a document type plus a unique identifier indicating the cluster of one or more pages. The page classifier includes an automatic classifier subsystem. Users may add example documents to document types as training examples, and the system can also use classified documents as training examples. Given a set of training documents grouped into document types, the page classifier trainer creates a model which classifies documents into page types. Automatic classification may use plain text, text formatting, text location, and/or image-based features. For static forms, classification can be a hybrid model (image and text). The training process can run off-line in a periodic manner. Models built with customer-specific data are customer-specific. Page classification can output (for each page) a list of page types and scores (probabilities).

Document Assembler

The document assembler creates a document set from a batch by grouping pages into documents, using the pages and possible page types output by the page classifier. The document assembler applies constraints such as the expected document length for each document type. The resulting document set is stored in document processing system filesystem storage. Once the document set is constructed the associated batch entity is updated.

Document Set Editor/Reviewer

This application can have a UI and the ability to reclassify documents, merge the documents, split the pages from one document and create another document, view the image on select of the page in a document, delete a page, audit all changes made to the document set once in this module for post analysis, and view the list of documents/pages under that document/the actual image for review, and approve the review once all the documents are reviewed.

Extraction Configurator

This system can have the ability configure field extraction by document type, customize the label in the UI, mark a field for force review, have a field hidden, extract machine printed fields, and associate confidence scores to the extracted values.

Validation Configuration

The system can have the ability to add validation rules and the ability to add formatting rules based on the data-type.

Document Exporter

The document export service can be driver pluggable to support different target destinations and formats. A generic XML driver can be provided (AIF proprietary format).

Domain Tier

Document-Package Entity Definition

The Document-Package (“Package”) entity can be used to model and represent specific collections of documents used in business process workflows such as mortgage loan approval. In addition to the set of documents, a package contains metadata that conforms to a defined schema (that describes the type of business task being performed) and a set of business rules that can be used in conjunction with the metadata to validate the content, integrity, and completeness of the associated set of documents. A Doc-Package entity can include a GUID, a name, a Document-Set instance GUID, a reference to metadata-schema, package metadata, a list of business RuleSet references; and a list of eFolder and attachment locations. Metadata schemas can be implemented as JSON schemas. Schemas can be built from other schemas, for example the metadata associated with a Fannie Mae loan can be built from a base loan schema but contain additional business rules specific to that loan type. If required, it can be possible to auto-generate web forms from the schema for data input. The schema can be used to validate input data.

LOS Connector (Loan Ingest Functionality)

The LOS connector is responsible for interacting with a Loan Origination System, discovering new loans to be processed, and creating document-packages to represent those loans. An administrator can configure the LOS connector from the document processing system-PTL/document processing system-CLI to communicate with a specified loan-origination-system (LOS) to access information about in-process loans. A LOS connector can periodically query the specified LOS to determine the set of in-process loans. For newly discovered loans the LOS connector can query the LOS for specific loan metadata (e.g., loan-id, last-modified timestamp, assigned loan processor and underwriter, . . . ). As a LOS connector I can listen to the LOS for updated loan information, if the LOS provides an event push mechanism (e.g., webhook or websocket). The LOS connector can use pluggable drivers for communicating with different LOSs. An LOS connector can create/register all newly discovered loans in document processing system by using the Package Manager to create corresponding package instances.

Package Manager

This service can provide a configuration UI and a UI for manually creating, reading, updating, and deleting package instances. This service implements the CRUD operations associated with loan definitions. This service can provide a REST API for configuration, and execution of CRUD operations against packages. For newly discovered loans the document processing system-PM can query the LOS for specific loan metadata (e.g., loan-id, last-modified timestamp, assigned loan processor, and underwriter). A document processing system-PM can listen to the LOS for updated loan information, if the LOS provides an event push mechanism (e.g., webhook or websocket). The document processing system-PM can use pluggable drivers for communicating with different LOSs. A document processing system-PM can create and register all newly discovered loans in the document processing system loan database (create loan entities). A document processing system-PM can publish an event onto the message bus to indicate that a package definition has been created or updated.

Batch Manager/Preprocessor

This service can be headless. This service can provide a REST API for accessing information about batches. The batch-manager listens on the message bus for loan creation and update messages. When a new loan is detected the batch-manager creates a separate execution context for the loan that is responsible for continuously scanning all batch source locations associated with the loan looking for content that has not yet been processed. Loan definitions are accessed using REST queries to the document processing system-LRS. A watcher can be created for each batch source location in the loan definition by instantiating an appropriate driver based on source type (e.g., LOS, filesystem folder, e-mail, web-scanner, or Dropbox). An LOS can provide batch information in one of the following forms: (1) eFolder location (virtual filesystem folder), (2) raw bytestream, (3) email, or (4) URI to a content repository. An LOS driver may utilize base content drivers to retrieve batch data. Each watcher can download any batches that have not already been processed or are currently being processed, and analyze them. A set of checks is run on each downloaded batch to ensure that it is ready to be processed. Checks include, but are not limited to: (1) the format of the batch and its content are supported, (2) the batch and/or its contents are not password protected, and (3) the batch and its contents are not corrupted. If any of the checks fail a batch rejection notification is generated. It can be possible for the LOS or consumer portal to subscribe for batch rejection notifications.

A batch entity in the document processing system database is created for each batch that is not rejected. The entity can contain references to the location of the raw data associated with the batch. The list of batch references associated with the corresponding loan entity is also updated. An event can be published to the message bus for each newly discovered batch. Raw data for batches can be stored so that they are accessible from all cluster nodes to enhance parallel processing (consider a clustered filesystem such as HDFS or CephFS).

“Batch Process” Definition

A batch processing workflow can include steps such as preprocessing the batch, splitting a batch into single pages, executing the page process (with some parameters) for all pages in the batch, assembling documents using results from page processing, using page classification scores, document language model, and batch-specific constraints, manually reviewing the document set (only if classification confidence is below a threshold value), executing a document process (with some parameters) for each document, joining all document processes, updating batch checksum and timestamp values in the loan entity, and cleaning up temporary files (compliance).

“Document Process” Definition

A document processing workflow is a sequence of steps such as: extracting data from each page in the document; OCR/ICR field extraction driven by image-profile, document region, or anchor text; manual field extraction (possibly machine assisted); and automated validation of extracted data. Validation can be accomplished using business rules executed by the rules engine, manual validation of extracted data, and/or export document to LOS.

“Single Page Process” Definition

A single page process is a sequence of steps such as: testing whether the page contains searchable text/form data, and if page contains text data, then extract text data. If not, then perform cleanup/enhancement, OCR, and classify page.

Loan Processing Service

This application has a UI. As a loan processing service (document processing system-LPS), the application listens on the message bus for loan creation, update, and batch update events. When a loan or batch update occurs a notification is optionally sent to an operator asking whether the processing workflow can begin. Once the loan or batch processing has been approved this service requests the workflow engine to execute the batch process on a list of batches.

Operator Home Page

A loan processor can have the ability to view currently active and/or completed loans that have been assigned to the team. A summary of each loan can be presented as a row in a grid. In addition to basic identification and status information, the summary can include key performance indicators (KPIs) obtained by running rule sets assigned to the loan. The list of displayed loan properties is configurable. The grid is sortable on one or more properties. Attribute based filtering is provided to narrow the set of displayed loans. A drill-down capability is provided to view details of a specific loan (individual documents, rulesets, etc.). Each loan can have a set of available actions. Multiple loans can be selected, and a bulk action can be applied to the selected set.

Operator Task List

This view displays the list of tasks that are currently assigned to the logged-in user, and members of his or her team. Tasks can include: document-set review, manual extraction of data, and validation of extracted data. The view also displays tasks that can be claimed by the logged-in user. Each task can have an associated set of actions that that can be used to launch the tools required to either complete the task, and/or re-assign it to a colleague.

Loan Detail Viewer

The loan detail viewer enables the operator to understand the precise state of a loan, and take appropriate action on items that need to be addressed. The viewer is typically accessed via drilldown from the operator home page. The viewer displays a grid of documents associated with the loan. The viewer displays results from rule sets (checklists) associated with the documents that belong to the loan. Results may be directly tied to an individual document, or describe a relationship among data elements across a group of documents. Each document can have an associated set of actions based on its current state. The view can provide a history of the operations that have been applied to the loan.

Batch Detail Viewer

The batch viewer provides details on the processing of a specified batch. The viewer can access process instance information from the workflow engine.

1. A method comprising:
calculating a map of state change probabilities between a plurality of page types, the state change probabilities indicating at least the probability that a first page type will precede a second page type;
receiving a document package comprising a plurality of page items;
determining, using a classifier, page type probability vectors for each of the plurality of page items; and
calculating predicted page types for each of the plurality of page items based on the respective page type probability vectors and the map of state change probabilities.

2. The method of claim 1, further comprising:
determining a first chain of predicted page types for at least a subset of the plurality of page items;
calculating a first score for the first chain based on the page type probability vectors and the map of state change probabilities;
determining a second chain of predicted page types for the at least a subset of the plurality of page items;
calculating a second score for the second chain based on the page type probability vectors and the map of state change probabilities; and
determine that the first chain of predicted page types is more likely than the second chain based on the first score and the second score.

3. The method of claim 1, further comprising:
identifying one or more document type field regions of a particular page item of the plurality of page items based on a respective predicted page type for the particular page item;
obtaining data from the one or more document type field regions;
validating the data based on at least one validation rule for the respective predicted page type; and
storing the data in a database.

4. The method of claim 1, wherein the classifier calculates page type probability vectors using a convolutional neural network and/or optical character recognition of the respective page items.

5. The method of claim 1, wherein the map of state change probabilities includes the probability that a third page type will follow the second page type.

6. A system, comprising:
at least one processor; and
memory including instructions that, when executed by the at least one processor, cause the system to:
calculate a map of state change probabilities between a plurality of page types, the state change probabilities indicating at least the probability that a first page type will precede a second page type;
receive a document package comprising a plurality of page items;
determine, using a classifier, page type probability vectors for each of the plurality of page items; and
calculate predicted page types for each of the plurality of page items based on the respective page type probability vectors and the map of state change probabilities.

7. The system of claim 6, wherein the instructions when executed further cause the system to:
determine a first chain of predicted page types for at least a subset of the plurality of page items;
calculate a first score for the first chain based on the page type probability vectors and the map of state change probabilities;
determine a second chain of predicted page types for the at least a subset of the plurality of page items;
calculate a second score for the second chain based on the page type probability vectors and the map of state change probabilities; and
determine that the first chain of predicted page types is more likely than the second chain based on the first score and the second score.

8. The system of claim 6, wherein the instructions when executed further cause the system to:
identify one or more document type field regions of a particular page item of the plurality of page items based on a respective predicted page type for the particular page item;
obtaine data from the one or more document type field regions;
validate the data based on at least one validation rule for the respective predicted page type; and
store the data in a database.

9. The system of claim 6, wherein the classifier calculates page type probability vectors using a convolutional neural network and/or optical character recognition of the respective page items.

10. The system of claim 6, wherein the map of state change probabilities includes the probability that a third page type will follow the second page type.
